(19) United States
(12) Patent Application Publication
(10) Pub. No.: US 2025/0245712 A1
(43) Pub. Date: Jul. 31, 2025

(54) STORE SEARCH DATA PIPELINE

(71) Applicant: Target Brands, Inc., Minneapolis, MN (US)

(72) Inventors: Kiran Dhotre, Minneapolis, MN (US); Suresh N, Salem (IN)

(21) Appl. No.: 18/426,473

(22) Filed: Jan. 30, 2024

(51) Int. Cl. G06Q 30/0601

(52) U.S. Cl. CPC G06Q 30/0625; G06Q 30/0639

(57) ABSTRACT

Methods and systems for streaming data through a data pipeline to a search database for powering a search tool usable by a retail enterprise are disclosed. Input item content data may be received from real-time data sources at an ingestor platform having a plurality of separate ingestor services. The input item content data may be provided to intermediate streaming data queues within the data pipeline, wherein each input data type is provided to a streaming data queue independently from other data types. Using a hierarchy of aggregators operating within the data pipeline, the input item content data from the plurality of intermediate streaming data queues may be aggregated by at least aggregating the input item content data into searchable topics based on item identifiers associated with items available for purchase from the retail enterprise. The data aggregates may be provided to a search database configured to power a search tool.

### BACKGROUND

Retail enterprises consume large volumes of real-time data related to item information from multiple sources. For example, retail enterprises may maintain a store inventory database that may be accessed and searched to determine whether particular items are in stock and at what location within a retail store an item may be located. The store inventory database may be updated from a plurality of different data sources, and the received data may be reconfigured for storage in a second intermediate staging database before the data is sent to the store inventory database. When a full item record is retrieved from different data sources, the item record may be pushed from the intermediate staging database to the store inventory database and reverse indexed to facilitate a search. For this configuration to power search APIs, a set of static feeds needs to be synchronized in a single batch job. If one feed fails, that batch job would need to be terminated, thereby terminating ingestion of all feeds, including those which would otherwise be unaffected. Accordingly, traditional approaches for data stream processing within the context of a large enterprise system may experience processing delays and data loss. It is with respect to these and other general considerations that embodiments have been described.

### SUMMARY

In general, the present disclosure relates to a store search data pipeline. In a first aspect, example methods for streaming data to a search database for powering a search functionality usable by a retail enterprise may include receiving, at an ingestor platform operating within a data pipeline, the ingestor platform having a plurality of separate ingestor services, input item content data from real-time data sources, the input item content data including a plurality of data types and each data type being received at a different ingestor service and from a different data source, the plurality of data types including item identification data, item inventory data, and item location data indicating physical locations of items within a store layout of a physical retail location; for each data type, automatically providing the input item content data to an intermediate streaming data queue operating within the data pipeline, wherein item content data for each data type is provided to a streaming data queue independently from other data types, and wherein the data pipeline includes a plurality of distinct intermediate streaming data queues; using a hierarchy of aggregators operating within the data pipeline, continuously aggregating the input item content data from the plurality of intermediate streaming data queues into a plurality of data aggregates by at least aggregating the input item content data into searchable topics based on item identifiers associated with items available for purchase from the retail enterprise; and continuously providing the data aggregates from each of the plurality of searchable topics to a search database independently of others of the plurality of searchable topics, the search database being configured to power an enterprise search tool called by an Application Programming Interface (API), wherein the search database is a reverse index search database storing item content data within item records associated with items available for purchase from the retail enterprise and sorted based at least in part by the item identifiers.

In a second aspect, example systems for streaming data to a search database for powering a search functionality usable by a retail enterprise may include a data storage device for storing data; and a processor that executes the data to cause the system to: receive, at an ingestor platform operating within a data pipeline, the ingestor platform having a plurality of separate ingestor services, input item content data from real-time data sources, the input item content data including a plurality of data types and each data type being received at a different ingestor service and from a different data source, the plurality of data types including item identification data, item inventory data, and item location data indicating physical locations of items within a store layout of a physical retail location; for each data type, automatically the input item content data to an intermediate streaming data queue operating within the data pipeline, wherein each data type is provided to a streaming data queue independently from other data types and wherein the data pipeline includes a plurality of distinct intermediate streaming data ques; using a hierarchy of aggregators operating within the data pipeline, continuously aggregate the input item content data from the plurality of intermediate streaming data queues by at least aggregating the input item content data into searchable topics based on item identifiers associated with items available for purchase from the retail enterprise; and continuously provide data aggregates to a search database configured to power an enterprise search tool called by an Application Programming Interface (API), wherein the search database is a reverse index search database storing item content data within item records associated with items available for purchase from the retail enterprise and sorted based at least in part by the item identifiers.

In a third aspect, an example computer-readable non-transitory memory storing data may, when executed by a processor of a computer, causes the computer to: receive, at an ingestor platform operating within a data pipeline, the ingestor platform having a plurality of separate ingestor services, input item content data from real-time data sources, the input item content data including a plurality of data types and each data type being received at a different ingestor service and from a different data source, the plurality of data types including item identification data, item inventory data, and item location data indicating physical locations of items within a store layout of a physical retail location; for each data type, automatically the input item content data to an intermediate streaming data queue operating within the data pipeline, wherein each data type is provided to a streaming data queue independently from other data types and wherein the data pipeline includes a plurality of distinct intermediate streaming data ques; using a hierarchy of aggregators operating within the data pipeline, continuously aggregate the input item content data from the plurality of intermediate streaming data queues by at least aggregating the input item content data into searchable topics based on item identifiers associated with items available for purchase from the retail enterprise; and continuously provide data aggregates to a search database configured to power an enterprise search tool called by an Application Programming Interface (API), wherein the search database is a reverse index search database storing item content data within item records associated with items available for purchase from the retail enterprise and sorted based at least in part by the item identifiers.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an example network environment where a store search data pipeline may be implemented, according to an example.

FIG. 2 illustrates an example flow diagram among components of a store search data pipeline, according to an example.

FIG. 3 illustrates an example flow diagram among components of a store search data pipeline, according to an example.

FIG. 4 illustrates an example flow diagram among components of a store search data pipeline for streaming data into a search database for powering a digital search tool, according to an example.

FIG. 5 illustrates a user interface for displaying output of a search tool for retrieving item data streamed from a store search data pipeline, according to an example.

FIG. 6 illustrates a user interface for displaying output of a search tool for retrieving item data streamed from a store search data pipeline, according to an example.

FIG. 7 illustrates an example method for streaming data via a store search data pipeline to a search database, according to an example.

FIG. 8 illustrates an example block diagram of a virtual or physical computing system usable to implement aspects of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

As briefly described above, embodiments of the present disclosure relate to a data pipeline for streaming data from a plurality of data sources to an inventory database for powering a search functionality usable by a retail enterprise. A retail enterprise may maintain an inventory database that may be accessed and searched to determine whether particular items are in stock at a particular store, an item's location within a particular store (e.g., locations within a store layout an item can be found), or to determine online item availability information. For example, a retail enterprise employee may perform an inventory search on a computing device to determine whether a particular item is in stock at a particular retail store location, and at what location the item is located within the store (e.g., what aisle, what position within aisle). The inventory database may be a reverse index search database. The inventory database may be updated from a plurality of different data sources. The data sources can include, for example, changes in item inventory, the specific locations within the store at which the item may be located (e.g., batteries may be located in multiple places within a store, so an overall item inventory level is insufficient to determine inventory and location level), and changes to facet information (e.g., how item records are organized for purposes of a search using a search tool). Facet information may be representative of index fields within the reverse index search database that represent a category of information.

Traditional approaches for streaming data from multiple data sources to a search database, such as the inventory database, may include consolidating each of the streaming data sources into an intermediate database. The intermediate database may collect and associate inventory levels, facet information, and item locations to generate a payload which is periodically written into the inventory database. However, an intermediate database may be used to rehydrate item records with a full set of item attributes (e.g., each item may be associated with a particular location and facet and other attributes), wherein each item attribute may be retrieved from a different data source. Thus, if an item price changes, that price change may result in a rebuild of the entire item record. A batched approach to updating the inventory database may therefore cause a delay in reporting inventory levels. Additionally, implementations that utilize third-party cloud infrastructure resources for the intermediate staging of streaming data may be costly in terms of the amount of computing resources required.

The data pipeline described herein includes an ingestor platform having a plurality of ingestion tools or separate ingestor services. Each separate ingestion service may collect item content data from a different real-time data source or from a combination of data sources. The item content data received at the ingestor platform may then be provided to intermediate streaming data queues, such as intermediate Kafka streams. Groupings of intermediate streaming data queues may be aggregated using a hierarchy of aggregators operating within the data pipeline. Ultimately, the item content data is provided to the reverse index search database for powering a search functionality. Using this approach, item content data may flow through the data pipeline to the search database as soon as data is received in real-time and with no interdependency on other data types. By implementing a data pipeline with a distributed set of platforms rather than aggregating all item content data at once, item content data travels faster to the reverse index search database and retail enterprise team members can access the relevant and most up-to-date item information more easily.

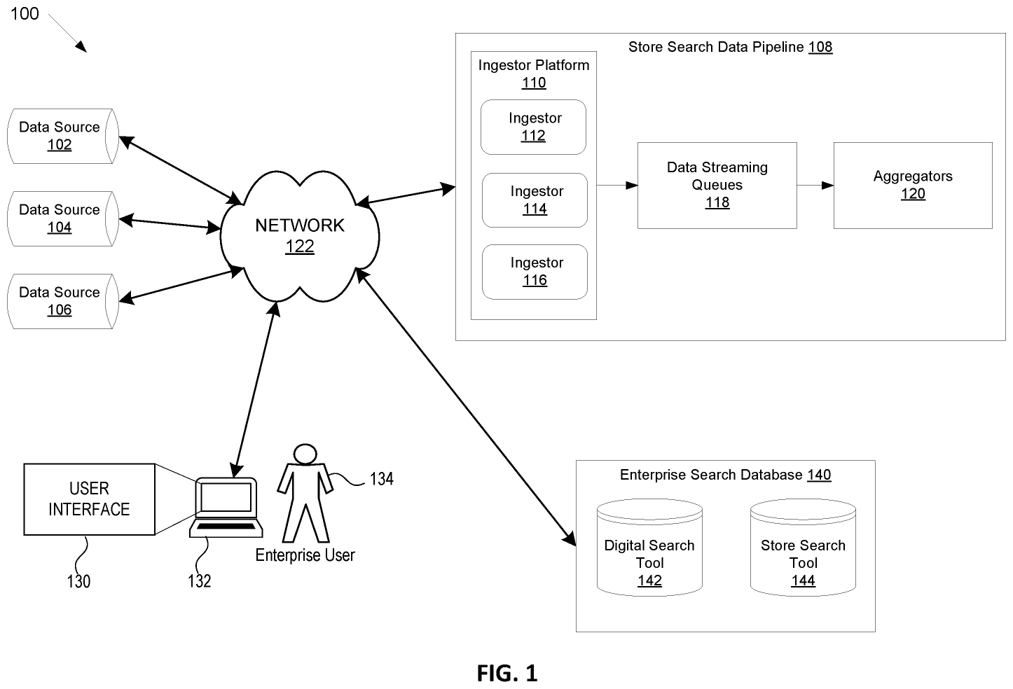

FIG. 1 illustrates an example network environment 100 where a store search data pipeline 108 may be implemented. As will be described in more detail below, the network environment 100 may include external data sources 102, 104, 106, a store search data pipeline 108, a network 122, enterprise search systems 140, and a computing device 132 associated with an enterprise user 134. The store search data pipeline 108 may be associated with a retail enterprise. The enterprise user 134 may be an employee of the retail enterprise.

In some examples, as described herein, network 122 may include a computer network, an enterprise intranet, the Internet, a LAN, a Wide Area Network (WAN), wireless transmission mediums, wired transmission mediums, other networks, and combinations thereof. Although network 122 is shown as a single network in FIG. 1, this is shown as an example and the various communications described herein may occur over the same network or a number of different networks.

The store search data pipeline 108 is configured to provide real-time item data from data sources 102, 104, 106 to the enterprise search systems 140. The store search data pipeline 108 may include an ingestor platform 110 having a plurality of separate ingestor tools or services 112, 114, 116. The ingestor services 112, 114, 116 may be configured to receive real-time input item content data type from a data source 102, 104, 106.

The data sources 102, 104, 106 may be sources for data relating to items available for purchase from the retail enterprise. For example, types of data that may be received at the ingestor platform 110 from a data source 101, 104, 106 include, without limitation, item change data, item location data, sales classification data, site taxonomy data, item availability data, item price data, and facet data. In examples, item location data includes physical locations of items within a store layout of a physical retail location.

In some examples, each ingestor service 112, 114, 116 may receive a different type of item content data from a separate data source 102, 104, 106. For example, ingestor 112 may receive input item content data from data source 102, ingestor 114 may receive input item content data from data source 104, and ingestor 116 may receive input item content data from data source 116. In some examples, multiple data sources may provide input item content data to a single ingestor service.

Once item content data from data sources 102, 104, 106 is received at the ingestor platform 110 of the store search data pipeline 108 at an ingestor 112, 114, 116, the item content data may be provided to an intermediate data streaming queue 118. The intermediate data streaming queues 118 may be Kafka streams. The intermediate data streaming queues 118 may receive item content data from the ingestors 112, 114, 116 and provide the item content data to further intermediate data streams, secondary ingestors, and/or aggregators. Item content data may move through intermediate data streaming queues 118 as soon as it is received and with no interdependency on other types of item content data.

The store search data pipeline 108 may include a hierarchy of aggregators 1120. Groupings of intermediate data streaming queues 118 may be aggregated into higher level collections at an aggregator 120. In examples, input item content data from a grouping of intermediate data streaming queues 118 may be aggregated with a primary aggregator. The aggregated data may then be provided to another intermediate streaming data queue 118, and then further aggregated with yet another intermediate data streaming queue 118 with a secondary aggregator. Aggregating the input item content data may include aggregating the data into searchable topics based on item identifiers associated with items available for purchase from the retail enterprise so that item information can be retrieved in response to a search request.

The aggregated data may be continuously provided to an enterprise search database 140 configured to power an enterprise search tool called by an Application Programming Interface (API). The enterprise search database may be a reverse index search database storing item content data associated with items available for purchase from the retail enterprise and sorted based at least in part by the item identifiers.

In examples, the enterprise search system 140 may power a store search tool 144 configured to look up item location (e.g., what aisle, what position within aisle) and item availability within the retail enterprise at a physical retail location. In other examples, the enterprise search system 140 may power a digital search tool 142 configured to determine item availability within the retail enterprise by combining in-store and online item availability information.

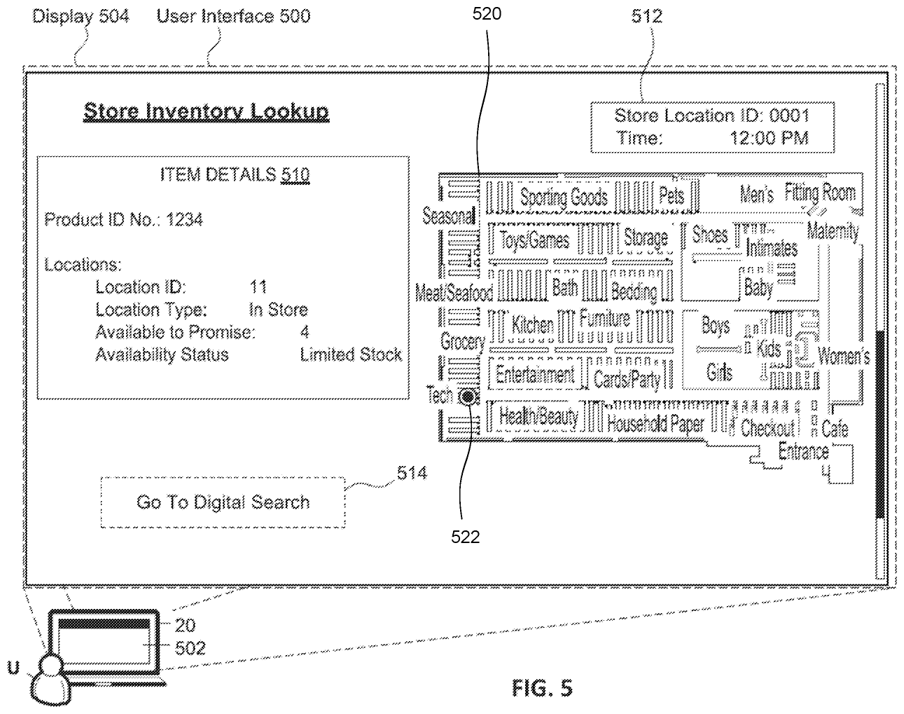

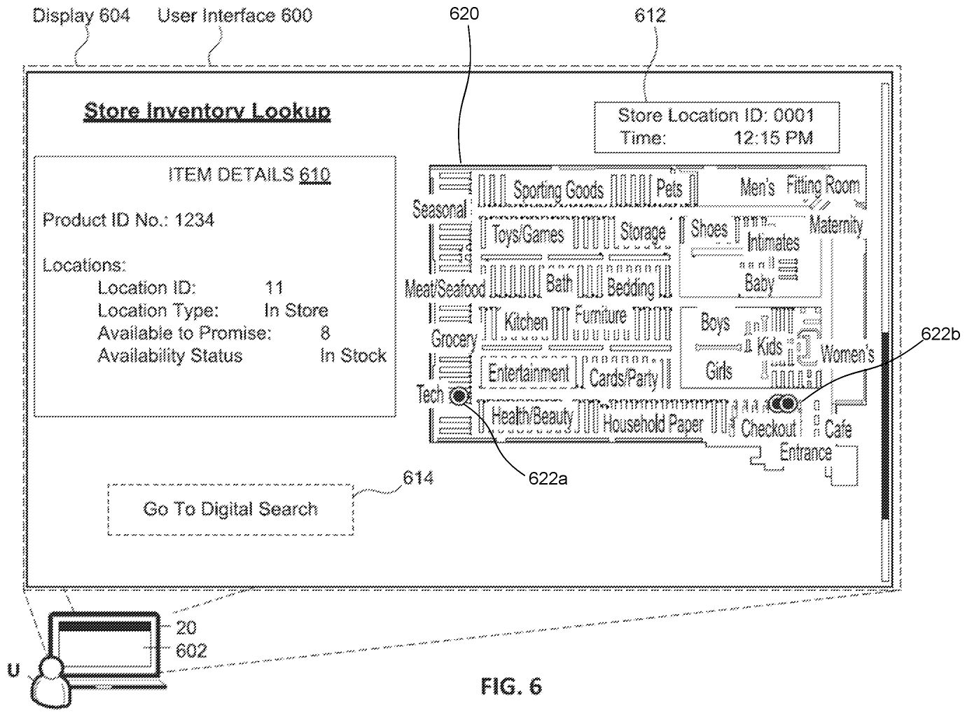

The store search tool 144 and digital search tool 142 may be accessed by a computing device 132 associated with an enterprise user 134. The enterprise user 134 may submit a request for item information, and a search tool 142, 144 may provide item details in response to the request. The item details may include item availability information and item location within a store. The item details may be displayed on a user interface 130. In some examples, the item location information may be displayed on a store layout or map of a physical retail location displayed on a user interface 130, such than an indicator is provided on the store layout or map indicating a location or locations within the store that an item is location. Example user interfaces 103 are described in more detail below with reference to FIGS. 5 and 6.

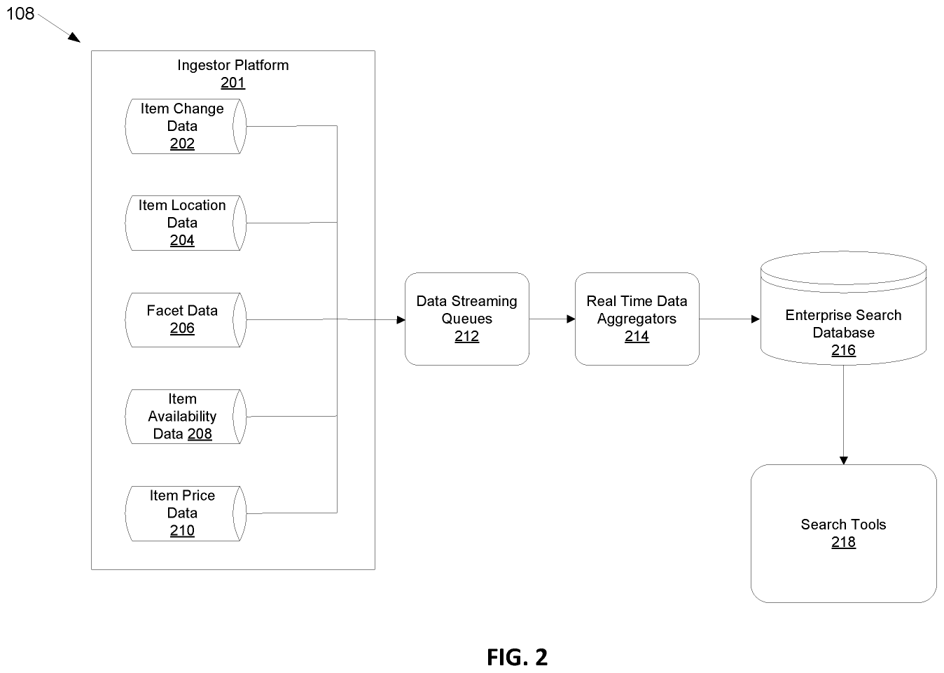

FIG. 2 illustrates an example flow diagram among components of the store search data pipeline 108 described with reference to FIG. 1. The store search data pipeline 108 includes an ingestor platform 201 having a plurality of ingestion tools or services 202, 204, 206, 208, 210. The ingestion services 202, 204, 206, 208, 210 are configured to receive item content data from external data sources. Each disparate or separate ingestion service 202, 204, 206, 208, 210 may be configured to receive a different type of data input. For example, ingestion service 202 may receive item change data, ingestion service 204 may receive item location data, ingestion service 206 may receive fact data, ingestion service 208 may receive item availability data, and ingestion service.

The item content data received at the ingestor platform may then be provided to an intermediate data streaming queue 212. The intermediate data streaming queues 212 may be Kafka streams. The store search data pipeline 108 may have a plurality of intermediate data streaming queues 212. In examples, each ingestion service may feed input data into a different intermediate data streaming queue 212.

In other examples, multiple ingestion services may feed input data into a single intermediate data streaming queue 212. Data within the intermediate data streams 212 may be provided to real-time data aggregators 214. The store search data pipeline 108 may have a hierarchy of aggregators to aggregate data into high level collections from a grouping of intermediate data streams. For example, input item content data from a grouping of intermediate data streaming queues 212 may be aggregated with a primary aggregator. The aggregated data may then be provided to another intermediate streaming data queue 212, and then further aggregated with yet another intermediate data streaming queue 212 with a secondary aggregator.

The aggregated data from the real-time data aggregators 214 may be provided to an enterprise search database 216. The enterprise search database 216 may be a reverse index search database storing information regarding items available for sale by the retail enterprise. The enterprise search database 216 may power search tools 218. The search tools 218 may include a store search tool configured to look up item location and item availability within the retail enterprise at a physical retail location. The enterprise search tools may further include a digital search tool configured to determine item availability within the retail enterprise by combining in-store and online item availability information. The search tools 218 may be accessed by an enterprise user associated with the retail enterprise in order to look up item and inventory information.

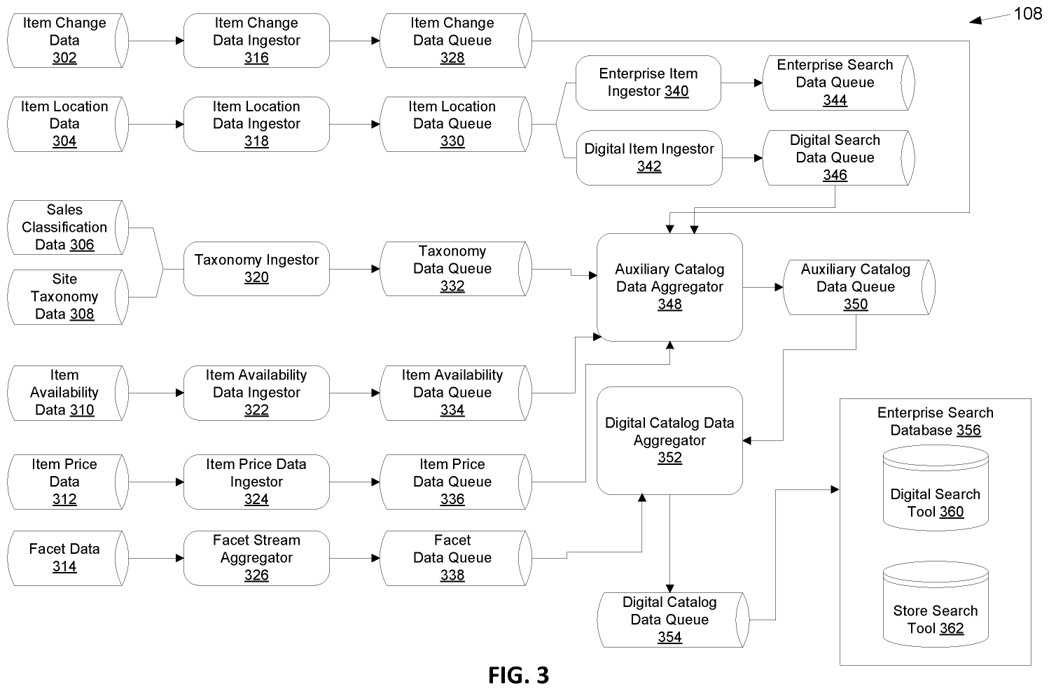

FIG. 3 illustrates an example flow diagram among components of the store search data pipeline 108 described with reference to FIG. 1. As described above with reference to FIGS. 1 and 2, a plurality of external data sources may provide data inputs to the store search data pipeline. External data sources 302, 304, 306, 308, 310, 312, 314 may provide item and facet information to the ingestor platform of the store search data pipeline 108 when there is a change in information. Therefore, external data sources 302, 304, 306, 308, 310, 312, 314 may provide updated item and facet information to the ingestor platform in real-time.

Each external data source 302, 304, 306, 308, 310, 312, 314 may feed data into a specified data ingestor within the ingestor platform, wherein the ingestor platform includes a plurality of ingestors 316, 318, 320, 322, 324. For example, item change data 302 may be provided to an item change data ingestor service 302, item location data 304 may be provided to an item location data ingestor 318, item availability data 310 may be provided to an item availability data ingestor 322, and item price data 312 may be provided to an item price data ingestor 324. In examples, multiple external data sources may feed data into a single ingestor service. For example, sales classification data 306 and site taxonomy data 308 may feed data inputs into a single taxonomy ingestor 320. In examples, an external data source may feed data directly into an aggregator. For example, facet data 314 (e.g., changes in the consumer facing facets) may be provided directly to a facet stream aggregator 326.

Once data from external data sources 302, 304, 306, 308, 310, 312, 314 is received and ingested by an ingestion service 316, 318, 320, 322, 324, the data may be immediately provided to an intermediate streaming data queue 328, 330, 332, 334, 336, 338. The intermediate streaming data queues 328, 330, 332, 334, 336, 338 may be Kafka streams. For example, the item change data ingestor 316 may feed data into the item change data queue 328, the item location data ingestor 318 may feed data into the item location data queue 330, the taxonomy ingestor 320 may feed data into the taxonomy data queue 332, the item availability data ingestor 322 may feed data into the item availability data queue 334, the item price data ingestor 324 may feed data into the item price data queue 336. Additionally, the facet stream aggregator 326 may feed aggregated facet information into a facet data queue 338.

Each data type from external data sources 302, 304, 306, 308, 310, 312, 314 may be immediately provided to an intermediate streaming data queue 328, 330, 332, 334, 336, 338 independent of the other data types such that there is no interdependency between data records. For example, if updated item location data 304 is received, but no updated item price data 312 is received, the updated item location data 304 may still be provided to an ingestion service 318 and sent to an intermediate streaming queue 330.

In examples, additional ingestor services may be integrated within the store search data pipeline 108 to ingest data from the intermediate streaming data queues. For example, the item location data queue 330 may provide streaming data to an enterprise item ingestor 304 and a digital item ingestor. Item location data 304 that is specific to physical retail store locations may be sent to the enterprise item ingestor 304. The digital item ingestor 342 may combine both in-store and online information. Ingestor services 340 and 342 may then feed data into additional intermediate data streaming queues, such as enterprise search data queue 344 and digital search data queue 346.

Groupings of intermediate streaming data queues may feed streaming data into an aggregator. In examples, the groupings of intermediate data streaming queues may first feed streaming data into a primary aggregator within a hierarchy of aggregators. For example, the item change data queue 328, the digital search data queue 346, the taxonomy data queue 332, the item availability data queue 334, and the item price data queue 336 may provide streaming data to an auxiliary catalog data aggregator 348. The auxiliary catalog data aggregator 348 may aggregate item data into searchable topics based on item identifiers (e.g., a uniqueue item identification code) associated with items available for purchase from the retail enterprise so that item information can be searched for in a reverse index search database. The primary aggregator 348 may not receiving streaming data from all intermediate data streams.

A primary aggregator, such as the auxiliary catalog data aggregator 348 may provide the aggregated data to another intermediate streaming data queue, such as an auxiliary catalog data queue 350. In examples, groupings of intermediate streaming data queues, including data aggregated from a primary aggregator, may feed streaming data into a secondary aggregatory within the hierarchy of aggregators. For example, the auxiliary catalog data queue 350 and the facet data queue 338 may feed streaming data into a digital catalog data aggregator 352. The digital catalog data aggregator 352 may further aggregate item data into searchable topics based on item identifiers so that item information can be searched for in a reverse index search database.

After the groupings of intermediate streaming data queues have been aggregated by the hierarchy of aggregators, the resulting aggregated data may be provided to an additional intermediate data streaming queue, such as the digital catalog data queue 354. The digital catalog data queue 354 may then provide the aggregated data to the enterprise search database 356, which may be a reverse index search database. The enterprise search database 356 may be configured to power a digital search tool 360 and a store search tool 362. The components of the store search data pipeline 108 described with reference to FIG. 3 enable changes to item records (e.g., item availability, item location) to be received by the enterprise search database 356 quickly because a change to one data type within an item record can flow through the store search data pipeline 108 independently from other data types. Thus, the search tools 360, 362 are configured to retrieve the most up-to-date item information from the enterprise search database 356.

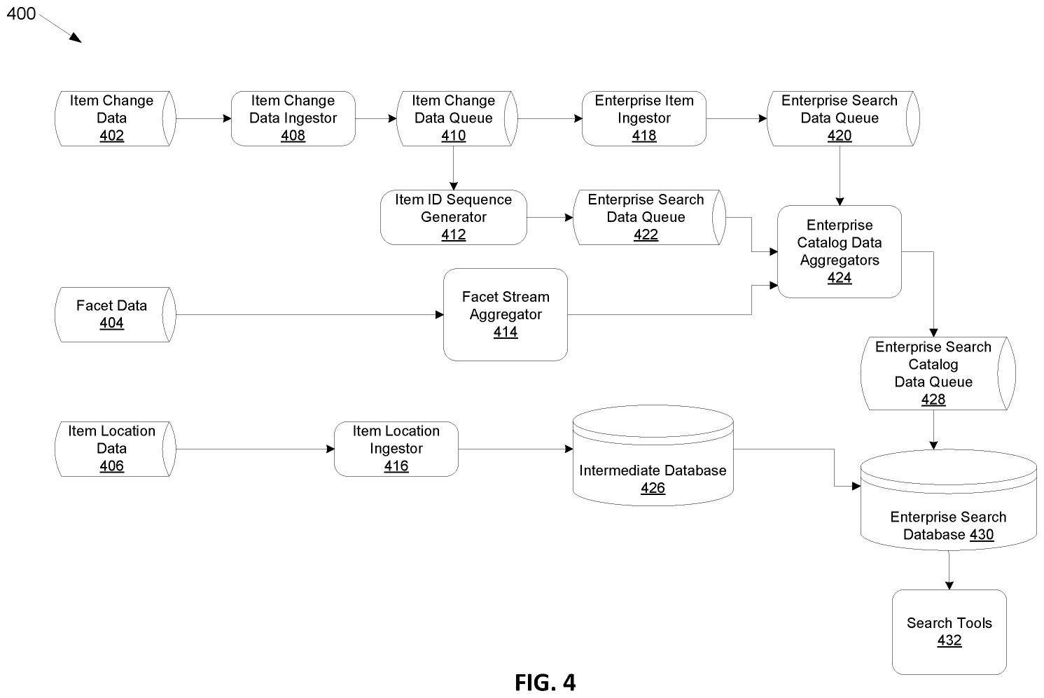

FIG. 4 illustrates an example flow diagram among components of a store search data pipeline 400 for streaming data into a search database 430 for powering a digital search tool, according to an example. As described above with reference to FIGS. 1-3, the store search data pipeline 400 may receive data inputs from a plurality of separate external data sources 402, 4044, 406. Examples of external data sources may include, without limitation, item change data 402, facet data 404, and item location data 406. The data inputs may be received by ingestor services 408, 416. For example, the item change data 402 may be received by an item change data ingestor 408, and the item location data 406 may be received by an item location ingestor 416. Thus, updates and changes to item data and item location data may be received in real-time and ingested by an ingestion service designated to receive a specific type of input data.

In examples, facet data 404 (e.g., how item records are organized for purposes of a search using a search tool) may be received and provided directly to an aggregator 414 within a hierarchy of aggregators operating within the data pipeline 400. The facet stream aggregator 414 may aggregate the facet data 404 to compile a structure for how item data and item records may be organized within a search database 403 such as a reverse index search database.

The store search data pipeline 400 may include additional layers of ingestors and intermediate data queues for ingesting and streaming data before groupings of data streams are aggregated. For example, the item change data queue 410 may feed data into an enterprise item ingestor 418, which may feed data into another intermediate streaming data queue, such as an enterprise search data queue 420. In examples, item change data may be provided from the item change data 410 to an item ID sequence generator, which may associate item change data with an item identifier associated with the item, wherein the item identifier may be a unique identification number. Item change data and item ID information may then be provided to an enterprise search data queue 422 for intermediate streaming before being fed into an enterprise catalog data aggregator 424. The enterprise catalog data aggregator 424 may aggregate item change data and facet data by aggregating the item change data into searchable topics using the item ID information and based on the item record structure for storing item information in the search database 430 as determined in part by the aggregated facet data. The aggregated data from the enterprise catalog data aggregator 424 may be streamed in an enterprise search catalog data queue 428 before being provided to the enterprise search database 430.

In examples, item data may be staged in an intermediate database 426. An intermediate database 426 may be used for streaming data into the search database 430 that will ultimately power a digital search tool. For example, the item location data 406 ingested by the item location ingestor service 416 may be temporarily stored in an intermediate database 426. A scheduler tool may be utilized to schedule transfer of data from the intermediate database 426 to the enterprise search database 430. The scheduler tool may schedule data transfers at regularly intervals, such as every 10 minutes.

The enterprise search database 430 may be a reverse index search database that powers search tools 432, such as the digital search tool 360 and the store search tool 363 discussed above with reference to FIG. 3.

FIG. 5 illustrates a user interface 500 for displaying output of a search tool for retrieving item data streamed from a store search data pipeline, according to an example. The user interface 500 may be presented on a screen 502 of a computing device 20. The computing device 20 may be associated with a user U, wherein the user may be an employee of a retail enterprise at a particular physical retail location. The user interface may be presented on a display 504 such as a touch screen display. The user interface 500 may include a display panel 512 indicating a store location ID associated with a particular physical store location and the time.

The user interface 500 may display output from of a search tool for retrieving item data streamed from the store search data pipeline 108 as described above with reference to FIGS. 1-3. Furthermore, the output may be from the digital search tool 142, 360 or store search tool 144, 362 described with reference to FIGS. 1 and 3. For example, user U, who may be an employee associated with the retail enterprise, may use an enterprise search tool to send a request for item information at a particular physical store location. The enterprise search tool, called by an Application Programming Interface (API), in response to the request, may search within an enterprise search database containing item data received from the store search data pipeline for item records. The item details 510 from the item record may then be displayed on the user interface 500. In examples, the item details 510 may include an item identifiers number. The item details 510 may further include item location information, such as a location ID (e.g., aisle 11), a location type (e.g., in store, online only), number of items available to promise (e.g., 4), and an availability status base on the number of items available to process (e.g., in stock, limited stock, out of stock).

In examples, the item location information within the enterprise search database includes the physical locations of items within a store layout of a physical retail location. In examples, the user interface 500 may include a store layout 520 of a physical retail location. The store layout 520 may include a plurality of aisles and shelves within a plurality of departments (e.g., seasonal, toys/games, sporting goods, pets) within the physical retail location. The store layout 520 may further include an indicator 522 indicating locations within the physical retail location where the item can be found. The indicator 522 displayed on the user interface may be automatically updated if the physical location of an item changes (e.g., an item is no longer available at a certain location within the store layout or an item is now available at an additional location within the sore layout).

In examples, the user interface 500 may include a selectable element 514 to launch a digital search tool. If, for example, the item details for the particular physical store location indicated that zero items were available to promise within the store, a digital search tool may be launched to determine item availability both in-stores and online.

FIG. 6 illustrates a user interface 600 for displaying output of a search tool for retrieving item data streamed from a store search data pipeline, according to an example. The user interface 600 may be presented on a screen 602 of a computing device 20. The computing device 20 may be associated with a user U, wherein the user may be an employee of a retail enterprise at a particular physical retail location. The user interface may be presented on a display 604 such as a touch screen display. The user interface 600 may include a display panel 612 indicating a store location ID associated with a particular physical store location and the time. The user interface 600 may be the user interface 500 described with reference to FIG. 5 except that the time has updated from 12:00 pm to 12:15 pm.

Similar to user interface 500, the user interface 600 may display output from of a search tool for retrieving item data streamed from the store search data pipeline 108 as described above with reference to FIGS. 1-3. Furthermore, the output may be from the digital search tool 142, 360 or store search tool 144, 362 described with reference to FIGS. 1 and 3. For example, user U, who may be an employee associated with the retail enterprise, may use an enterprise search tool to send a request for item information at a particular physical store location. The enterprise search tool, called by an Application Programming Interface (API), in response to the request, may search within an enterprise search database containing item data received from the store search data pipeline for item records. The item details 610 from the item record may then be displayed on the user interface 600. In examples, the item details 610 may include an item identifiers number.

The user interface 600 displays item details 610 for the same item identifier number as user interface 500. However, as 15 minutes of time has passed as indicated in display panel 612, the item details 610 may be updated as a result of changes in item data received from the store search data pipeline. For example, the item location ID and location type may remain the same from user interface 500, but the available to promise and availability status may be updated (e.g., changed from 4 to 8 items available to promise; availability status changed from limited stock to in stock). These changes to the item availability data may be received from an external data source by the store search data pipeline in order to flow to the enterprise search database in real-time, regardless of whether other types of item data associated with the particular item were received and aggregated into the item record. For example, even if no updated item price data was received for the particular item, the updated item location information may flow through the intermediate data streams of the store search data pipeline into the enterprise search database used to power the search tools. In some examples, changes to item location within a physical retail store may be received when no changes to item availability data is received.

In examples, the item location information within the enterprise search database includes the physical locations of items within a store layout of a physical retail location. In examples, the user interface 600 may include a store layout 620 of a physical retail location. The store layout 620 may include a plurality of aisles and shelves within a plurality of departments (e.g., seasonal, toys/games, sporting goods, pets) within the physical retail location. In examples, some items, such as batteries, may be located at more than one location within the physical retail location. The store layout 620 may therefore further include indicators 622a, 622b indicating locations within the physical retail location where the item can be found. Batteries, for example, may be found within the tech department, but they may also be found near the checkout. The indicators 622a, 622b displayed on the user interface may be automatically updated if the physical location of an item changes (e.g., an item is no longer available at a certain location within the store layout or an item is now available at an additional location within the sore layout).

As the user interface 600 displays item details 610 for the same item identifier number as user interface 500, but includes updated item details 610 as a result of changes in item data received from the store search data pipeline, the item details 610 indicate eight items available to promise and the store layout 620 indicates multiple locations 622a, 622b where the item can be found within the physical retail location, as compared to the item details 510 discussed with reference to FIG. 5, which shows only four items available to promise and the store layout 520 indicates only one location 522 where the item can be found within the physical retail location. By receiving changes to item location data in real-time, more up-to-date and therefore more accurate item information can be provided to a user U using the enterprise search tool to identify the location of a particular item at a particular physical store location. The user interface 600 may also include a selectable element 614 to launch a digital search tool.

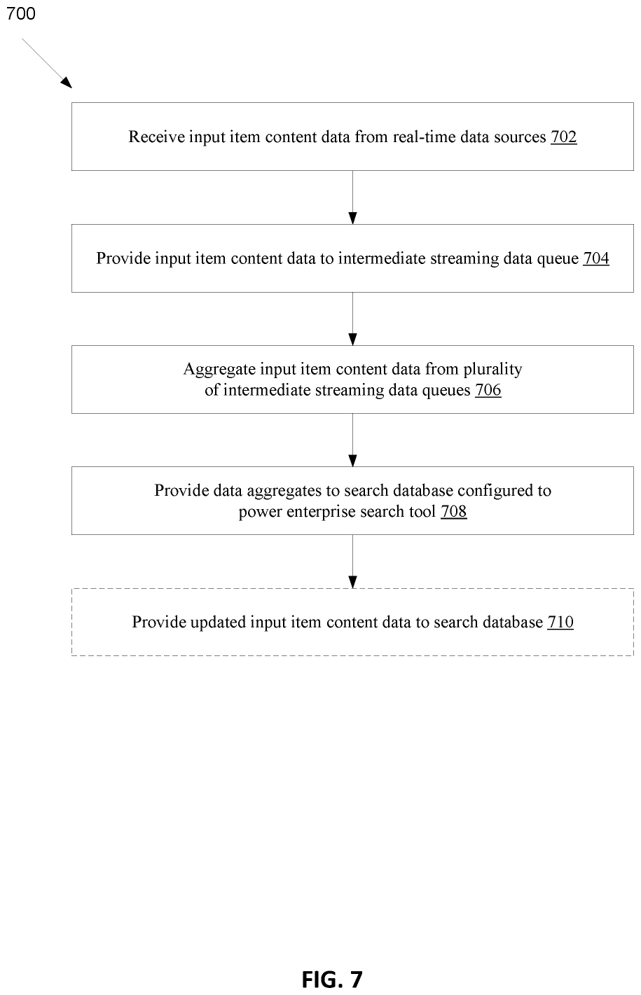

FIG. 7 illustrates an example method 700 for streaming data via a store search data pipeline to a search database, according to an example. The store search data pipeline data pipeline may be the store search data pipeline 108 as described above with reference to FIGS. 1-3. The search database may be the search database 140, 216, 356, 430 described with reference to FIGS. 1-4.

The method 700 may include receiving at an ingestor platform operating within a data pipeline input item content data from real-time data sources at operation 702. The ingestor platform may have a plurality of separate ingestor services and the input item content data may include a plurality of data types. In examples, each data type may be received at a different ingestor service and from a different data source. Example data types received from data sources at operation 702 may include, without limitation item change data, item location data, sales classification data, site taxonomy data, item availability data, item price data, and facet data.

At operation 704, for each data type received at operation 702, the input item content data may be automatically provided to an intermediate streaming data queue operating within the data pipeline. At operation 704, each data type is provided to a streaming data queue independently from other data types such that there is no interdependency between data types. Thus, input for one data type related to a particular item may be provided to an intermediate streaming data queue regardless of whether input for a second data type for that particular item has been received by the data pipeline.

At operation 706, a hierarchy of aggregators operating within the data pipeline may be used to continuously aggregate the input item content data from the plurality of intermediate streaming queues. Operation 706 may include aggregating the input item content data into searchable topics based on item identifiers associated with items available for purchase from the retail enterprise. An example hierarchy of aggregators is described in more detail with reference to FIG. 3. In examples, aggregating the input item content data at operation 706 may include aggregating input item content data from a first set of intermediate streaming data queues with a primary aggregator, provide the aggregated data from the primary aggregator into an intermediate streaming data queue within a second set of intermediate streaming data queues, and aggregating the input item content data from the second set of intermediate streaming data queues with a secondary aggregator. Thus, item data may be aggregated at various stages within the store search data pipeline.

At operation 708, data aggregates may be continuously provided to a search database configured to power an enterprise search tool called by an Application Programming Interface (API). The external database may be a reverse index search database storing item content data within item records associated with items available for purchase from the retail enterprise and sorted based at least in part by item identifier information (e.g., item ID number).

In examples, at operation 710, updated input item content data associated with an item available for purchase may be provided to the search database (e.g., the reverse index search database). The updated item content data may then be displayed on a user interface in response to a search request from a user device associated with the retail enterprise for item location information or item availability information, as described in more detail with respect to FIGS. 5 and 6. The updated item content data provided to the search database may causes a change to a portion of an item record for the item available for purchase, wherein the portion is less than the entire item (e.g., there is a change to item location information but no change to item availability location).

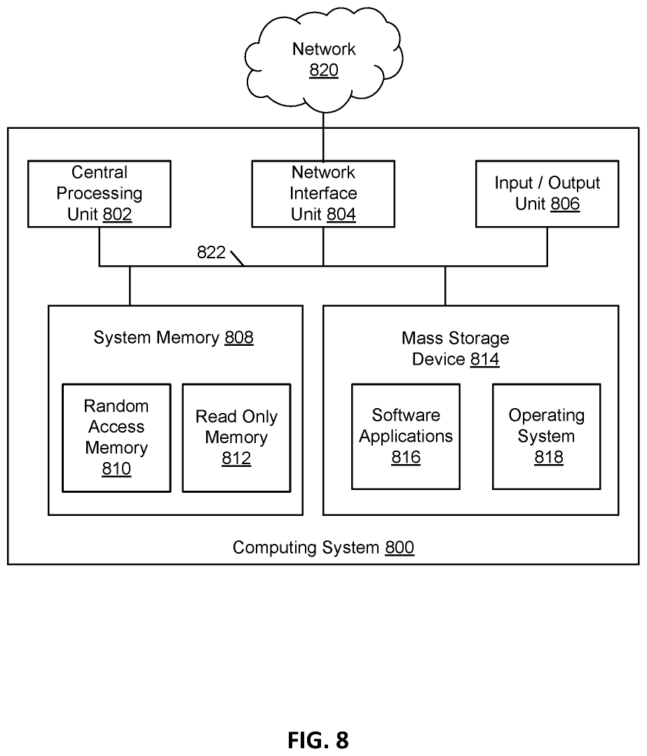

FIG. 8 illustrates an example block diagram of a virtual or physical computing system 800. One or more aspects of the computing system 800 can be used to implement the store search data pipeline 108 or other systems described above in conjunction with FIG. 1.

In the embodiment shown, the computing system 800 includes one or more processors 802, a system memory 808, and a system bus 822 that couples the system memory 808 to the one or more processors 802. The system memory 808 includes RAM (Random Access Memory) 810 and ROM (Read-Only Memory) 812. A basic input/output system that contains the basic routines that help to transfer information between elements within the computing system 800, such as during startup, is stored in the ROM 812. The computing system 800 further includes a mass storage device 814. The mass storage device 814 is able to store software instructions and data. The one or more processors 802 can be one or more central processing units or other processors.

The mass storage device 814 is connected to the one or more processors 802 through a mass storage controller (not shown) connected to the system bus 822. The mass storage device 814 and its associated computer-readable data storage media provide non-volatile, non-transitory storage for the computing system 800. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 1000.

According to various embodiments of the invention, the computing system 800 may operate in a networked environment using logical connections to remote network devices through the network 820. The network 820 is a computer network, such as an enterprise intranet and/or the Internet. The network 820 can include a LAN, a Wide Area Network (WAN), the Internet, wireless transmission mediums, wired transmission mediums, other networks, and combinations thereof. The computing system 800 may connect to the network 820 through a network interface unit 804 connected to the system bus 822. It should be appreciated that the network interface unit 804 may also be utilized to connect to other types of networks and remote computing systems. The computing system 800 also includes an input/output controller 806 for receiving and processing input from a number of other devices, including a touch user interface display screen, or another type of input device. Similarly, the input/output controller 806 may provide output to a touch user interface display screen or other type of output device.

As mentioned briefly above, the mass storage device 814 and the RAM 810 of the computing system 800 can store software instructions and data. The software instructions include an operating system 818 suitable for controlling the operation of the computing system 800. The mass storage device 814 and/or the RAM 810 also store software instructions, that when executed by the one or more processors 802, cause one or more of the systems, devices, or components described herein to provide functionality described herein. For example, the mass storage device 814 and/or the RAM 810 can store software instructions that, when executed by the one or more processors 802, cause the computing system 800 to receive and execute managing network access control and build system processes.

In accordance with the present disclosure, and as reflected in the embodiments below, the store search data pipeline has a number of technical advantages over existing systems. In particular, referring to FIGS. 1-8 overall, the store search data pipeline provides an advantageous framework for streaming item data from a plurality of external data sources in order to stream item data to a search database quickly and without delays caused by traditional intermediate staging databases used to rehydrate item records with a full set of item attributes. Rather, using a data pipeline comprising an ingestion platform having a plurality of separate ingestion services and intermediate streaming data queues, separate data input types can be ingested by the data pipeline and continue streaming through the data pipeline without a delay cause by waiting for a full item record to be received. This enables real-time reporting of location and inventory levels that may be unavailable using a traditional batched approach to updating item and location information, including inventory levels, in a database. Moreover, an ingestion platform having a plurality of distinct ingestion services permits high volumes of data to be received and ingested, even at unpredictable times. Additionally, by eliminating the use of intermediate storage databases to rehydrate item records, the streaming of data from external data sources to the search database is more efficient in terms of both cost and computing resources because storage resources, including third-party cloud infrastructure resources, can be minimized. The hierarchy of aggregators operating within the data pipeline further improves the data streaming process as it enables aggregation of different groupings of intermediate data queues at various times throughout the overall data streaming process. Furthermore, the streamed updates to item data ensures that updating the search indexing of a search database that receives this information may be less computationally complex (due to the incremental, smaller datasets received). Therefore, using the store search data pipeline described herein, the search database for powering enterprise search tools is updated continuously and dynamically as it receives real-time changes and updates to item records, which improves search results provided from the search tools because the search database includes the most accurate item record information. A retail enterprise employee using an enterprise search tool can therefore access relevant item records and item information more easily and more quickly. For example, item information includes item location data, which may include physical locations of items within a store layout of a physical retail store. In some examples, a particular item may be located at more than one physical location within the store layout if the item is in stock and the inventory levels are not low, but if inventory level is low the item may be located at only one physical location within the store layout. By receiving changes to item data, including item location data in real-time, more up-to-date and therefore more accurate item information can be generated and, in examples, provided to a user using the enterprise search tool to identify the most accurate location(s) of a particular item at a particular physical store location at a particular time.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For examples, while certain technologies described herein were primarily described in the context of queueing structures, technologies disclosed herein are applicable to data structures generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

What is claimed is:

1. A method of streaming data to a search database for powering a search functionality usable by a retail enterprise, the method comprising:
receiving, at an ingestor platform operating within a data pipeline, the ingestor platform having a plurality of separate ingestor services, input item content data from real-time data sources, the input item content data including a plurality of data types and each data type being received at a different ingestor service and from a different data source, the plurality of data types including item identification data, item inventory data, and item location data indicating physical locations of items within a store layout of a physical retail location;
for each data type, automatically providing the input item content data to an intermediate streaming data queue operating within the data pipeline, wherein item content data for each data type is provided to a streaming data queue independently from other data types, and wherein the data pipeline includes a plurality of distinct intermediate streaming data queues;
using a hierarchy of aggregators operating within the data pipeline, continuously aggregating the input item content data from the plurality of intermediate streaming data queues into a plurality of data aggregates by at least aggregating the input item content data into searchable topics based on item identifiers associated with items available for purchase from the retail enterprise; and
continuously providing the data aggregates from each of the plurality of searchable topics to a search database independently of others of the plurality of searchable topics, the search database being configured to power an enterprise search tool called by an Application Programming Interface (API), wherein the search database is a reverse index search database storing item content data within item records associated with items available for purchase from the retail enterprise and sorted based at least in part by the item identifiers.

2. The method of claim 2, wherein the plurality of data types includes item change data, item location data, and facet information.

3. The method of claim 1, wherein the enterprise search tool enables a store search functionality configured to look up item location and item availability within the retail enterprise at a physical retail location.

4. The method of claim 1, wherein the enterprise search tool enables a digital search functionality configured to determine item availability within the retail enterprise by combining in-store and online item availability information.

5. The method of claim 4, further comprising:
staging data from at least one input item content data type in an intermediate staging database within the data pipeline before providing the data to the reverse index search database.

6. The method of claim 5, wherein a scheduler tool operates to push data from the intermediate staging database to the reverse index search database at a predetermined schedule.

7. The method of claim 6, wherein the predetermined schedule is every 10 minutes.

8. The method of claim 1, further comprising:
providing updated input item content data associated with an item available for purchase from the retail enterprise to the reverse index search database, wherein the updated item content data is displayed on a user interface in response to a search request from a user device associated with a physical retail location of the retail enterprise for item location information or item availability information, and wherein the updated item content data causes a change to a portion of an item record for the item available for purchase, the portion being less than the entire item record.

9. The method of claim 8, wherein the change to the item record is a change to the item location within a physical retail store.

10. The method of claim 8, wherein the updated item content data displayed on the user interface includes an indicator of a physical location of the item within a store layout of the physical retail location.

11. The method of claim 1, wherein continuously aggregating the input item content data from the plurality of intermediate streaming data queues comprises:
aggregating input item content data from a first set of intermediate streaming data queues with a primary aggregator;
providing the aggregated data from the primary aggregator into an intermediate streaming data queue within a second set of intermediate streaming data ques; and
aggregating the input item content data from the second set of intermediate streaming data queues with a secondary aggregator.

12. A system for streaming data to a search database for powering a search functionality usable by a retail enterprise, the system comprising:
a data storage device for storing data; and
a processor that executes the data to cause the system to:
receive, at an ingestor platform operating within a data pipeline, the ingestor platform having a plurality of separate ingestor services, input item content data from real-time data sources, the input item content data including a plurality of data types and each data type being received at a different ingestor service and from a different data source, the plurality of data types including item identification data, item inventory data, and item location data indicating physical locations of items within a store layout of a physical retail location;
for each data type, automatically the input item content data to an intermediate streaming data queue operating within the data pipeline, wherein each data type is provided to a streaming data queue independently from other data types and wherein the data pipeline includes a plurality of distinct intermediate streaming data ques;
using a hierarchy of aggregators operating within the data pipeline, continuously aggregate the input item content data from the plurality of intermediate streaming data queues by at least aggregating the input item content data into searchable topics based on item identifiers associated with items available for purchase from the retail enterprise; and
continuously provide data aggregates to a search database configured to power an enterprise search tool called by an Application Programming Interface (API), wherein the search database is a reverse index search database storing item content data within item records associated with items available for purchase from the retail enterprise and sorted based at least in part by the item identifiers.

13. The system of claim 12, wherein the plurality of data types includes item change data, item location data, and facet information.

14. The system of claim 12, wherein the enterprise search tool enables a store search functionality configured to look up item location and item availability within the retail enterprise at a physical retail location.

15. The system of claim 12, wherein the enterprise search tool enables a digital search functionality configured to determine item availability within the retail enterprise by combining in-store and online item availability information.

16. The system of claim 12, wherein the data further causes the system to:
provide updated input item content data associated with an item available for purchase from the retail enterprise to the reverse index search database, wherein the updated item content data is displayed on a user interface in response to a search request from a user device associated with a physical retail location of the retail enterprise for item location information or item availability information, and wherein the updated item content data causes a change to a portion of an item record for the item available for purchase, the portion being less than the entire item record.

17. The system of claim 16, wherein the change to the item record is a change to the item location within a physical retail store.

18. The system of claim 12, wherein the updated item content data displayed on the user interface includes an indicator of a physical location of the item within a store layout of the physical retail location.

19. The system of claim 2, wherein the data that causes the system to continuously aggregate the input item content data from the plurality of intermediate streaming data queues further causes the system to:
aggregate input item content data from a first set of intermediate streaming data queues with a primary aggregator;
provide the aggregated data from the primary aggregator into an intermediate streaming data queue within a second set of intermediate streaming data ques; and
aggregate the input item content data from the second set of intermediate streaming data queues with a secondary aggregator.

20. A computer-readable non-transitory memory storing data that, when executed by a processor of a computer, causes the computer to:
receive, at an ingestor platform operating within a data pipeline, the ingestor platform having a plurality of separate ingestor services, input item content data from real-time data sources, the input item content data including a plurality of data types and each data type being received at a different ingestor service and from a different data source, the plurality of data types including item identification data, item inventory data, and item location data indicating physical locations of items within a store layout of a physical retail location;
for each data type, automatically the input item content data to an intermediate streaming data queue operating within the data pipeline, wherein each data type is provided to a streaming data queue independently from other data types and wherein the data pipeline includes a plurality of distinct intermediate streaming data ques;
using a hierarchy of aggregators operating within the data pipeline, continuously aggregate the input item content data from the plurality of intermediate streaming data queues by at least aggregating the input item content data into searchable topics based on item identifiers associated with items available for purchase from the retail enterprise; and
continuously provide data aggregates to a search database configured to power an enterprise search tool called by an Application Programming Interface (API), wherein the search database is a reverse index search database storing item content data within item records associated with items available for purchase from the retail enterprise and sorted based at least in part by the item identifiers.
